(19) United States
(12) Patent Application Publication
(10) Pub. No.: US 2012/0079521 A1
(43) Pub. Date: Mar. 29, 2012

(54) INCENTIVIZING ADVERTISEMENT VIEWING AND VALIDATING ASSOCIATED PURCHASE

(76) Inventors: Sharad K. Garg, Portland, OR (US); Mark D. Yarvis, Portland, OR (US)

(21) Appl. No.: 12/888,619

(22) Filed: Sep. 23, 2010

(51) Int. Cl. H04N 7/16

(52) U.S. Cl. 725/23

(57) ABSTRACT

A system and method are configured to provide an incentive to one or more viewer(s) to view (watch) one or more displayed advertisement(s), to notify advertiser(s) that the viewer(s) viewed the advertisement(s) and to identify one or more purchase(s) associated with the viewed advertisement(s).

### CROSS REFERENCE TO RELATED APPLICATIONS

The present disclosure is related to U.S. patent application Ser. No. 12/821,376, filed on Jun. 23, 2010, and entitled TECHNIQUES FOR CUSTOMIZATION.

### FIELD

The disclosure relates to providing an incentive to viewers to view displayed advertisement(s) and validating subsequent purchases associated with the viewed advertisements.

### BACKGROUND

In the United States, millions, if not billions, of dollars are spent each year on television advertising (“commercials”). However, many of these advertisements are not viewed, as television viewers may switch channels or take a break during display of the advertisement(s). Advertisers, especially, would like viewers to view these advertisements and to react to the advertisement by, e.g., purchasing an advertised product or service. Statistical methods exist for generally correlating sales with advertising. However, these methods may not objectively determine whether a particular viewer actually viewed a specific advertisement and, further, whether a purchase associated with the specific advertisement resulted.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates one example system embodiment consistent with the present disclosure;

FIG. 2 illustrates one example of viewer presence detection consistent with the present disclosure;

FIG. 3 illustrates a flowchart of example operations consistent with the present disclosure; and

FIG. 4 illustrates another flowchart of example operations consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, the present disclosure describes a system and method configured to provide an incentive to one or more viewer(s) to view (watch) one or more displayed advertisement(s), to notify advertiser(s) that the viewer(s) viewed the advertisement(s) and to identify one or more purchase(s) associated with the viewed advertisement(s). As used herein, “viewer” means a person and may include an “individual” and/or a “user”. Accordingly, viewer, person, individual and/or user may be used interchangeably.

### System Architecture

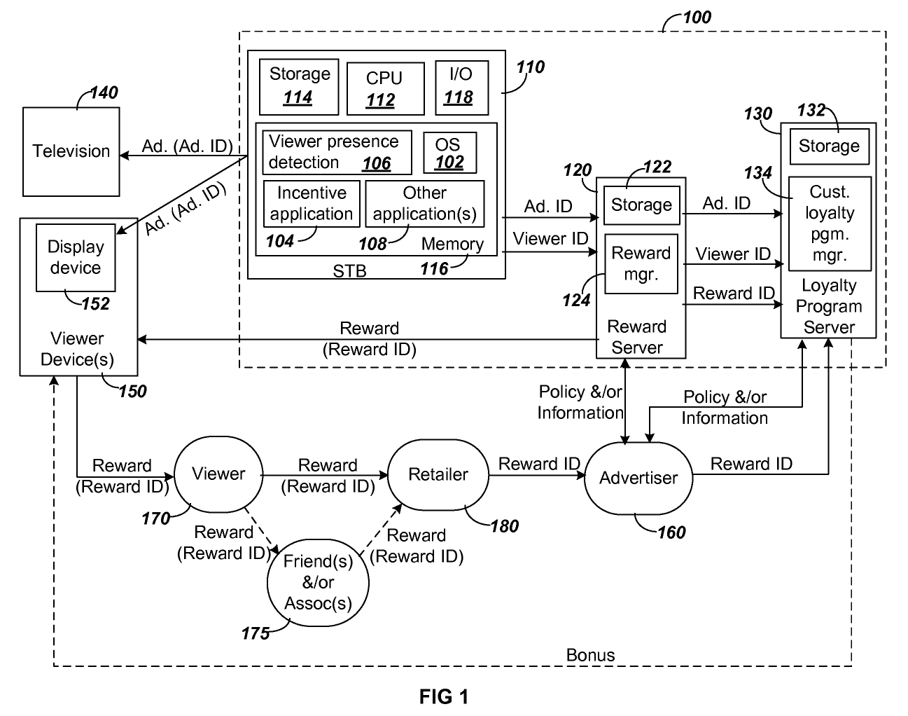

FIG. 1 illustrates one example system embodiment consistent with the present disclosure. System 100 of this embodiment generally includes a set-top box (“STB”) 110, a reward server 120 and/or a loyalty program server 130. Although depicted as separate components, the reward server 120 and the loyalty program server 130 may reside in a same circuitry. The system 100 is configured to be coupled to a television 140 and/or to one or more viewer device(s) 150. Viewer device(s) 150 may include a display device 152. For example, a display device may include a computer, e.g., desktop, laptop and/or handheld. The system 100 is configured to provide an incentive to viewer(s) to watch displayed advertisement(s), notify advertiser(s) that the advertisement(s) were viewed and to track purchase(s) associated with the watched advertisement(s). An advertiser 160 may be provided access to, and/or may set policy for, one or more components of the system 100, e.g., reward server 120 and/or loyalty program server 130, as will be described in more detail below.

For example, the system 100 may be configured to provide the viewer a reward as an incentive to view the displayed advertisement. In general, a reward is configured provide a benefit to a viewer in response to viewing an advertisement. For example, a reward may include a coupon that may be used online and/or in-store toward purchase of a product and/or service associated with the viewed advertisement. The coupon may be used one or more times and/or may be shared with friend(s) and/or associate(s). In another example, the reward may include points associated with an advertiser's customer loyalty program. Such points may be accrued and may be used to purchase product(s) and/or service(s). In another example, the reward may include an invitation to a non-public sales event associated with the advertiser and/or the viewed advertisement. A reward, however, is not limited to these examples.

The STB 110 may include one or more processor(s), e.g., CPU 112, storage 114, memory 116 and/or input/output ports and/or devices, e.g., I/O 118. CPU 112 may include one or more general purpose processor(s) and/or one or more special purpose processor(s), including, but not limited to, graphics processor(s), display processor(s), and/or digital signal processor(s) for, e.g., audio and/or security processor(s). Storage 114 may include any tangible storage medium as described herein. Storage 114 may include memory 116. The memory 116 may include an operating system, e.g., OS 102, an incentive application 104, a viewer presence detection module 106 and/or one or more other application(s) 108. I/O 118 may include one or more video input(s) and/or output(s), one or more audio input(s) and/or output(s) and/or one or more communication port(s). The STB 110 may include additional functional components, as will be understood by those skilled in the art.

The STB 110 is configured to provide video and audio content to the television 140 and/or to the display device 152. For example, STB 110 may be a media processor, such as Intel Media Processor CE 3100, available from Intel Corporation, Santa Clara, Calif. The video and/or audio content may include broadcast, broadband and/or stored content. The video and/or audio content may be received from, e.g., from a television antenna, a cable television system, a satellite television system, the Internet, and/or another device, e.g., DVD player. The video and/or audio content may include one or more advertisement(s) for product(s) and/or service(s). The video and/or audio content, including advertisement(s), may then be displayed on the television 140 and/or display device 152.

The STB 110 may be configured to provide advertisement(s) to television 140 and/or display device 152 for display. Incentive application 104 is configured to store information associated with each advertisement in storage 114. Information associated with each advertisement may include, but is not limited to, a unique identifier (Ad ID) for each displayed advertisement, scheduled display date and/or time for each advertisement, and/or video content, e.g., television channel and/or television program, that included the advertisement.

The incentive application 104 is configured to monitor displayed advertisement(s) and to detect Ad ID(s) associated with displayed advertisement(s) when the advertisement(s) are displayed. Detection of the Ad ID(s) may serve as trigger(s) for viewer presence detection 106 to initiate detecting and/or identifying viewer(s) present during display of the advertisement(s). In an embodiment, incentive application 104 may be configured to initiate viewer presence detection prior to display of the associated advertisement(s) based, e.g., on scheduled display date and/or time for an advertisement.

The STB 110 and viewer presence detection module 106 may be configured to determine whether viewer(s) are present during display of the advertisement(s) and/or to identify viewer(s) present during display of the advertisement(s). Viewer presence and/or identity may be determined based, at least in part, on processing images acquired from a viewing area of television 140 and/or display device 152, audio processing of sound signals acquired from the viewing area, sensing presence of one or more viewer device(s) 150 and/or sensing motion in the viewing area. “Viewing area”, as used herein, is a physical region of a room or other location from which the video content displayed on the television 140 and/or display device 152 may be viewed. Storage 114 may include a database (i.e., list) of identified viewer(s). The database may include a Viewer ID and associated viewer identification information for each previously identified viewer. Associated viewer identification information may include, but is not limited to, image processing data, audio processing data and/or viewer device data.

For example, I/O 118 may include a camera configured to acquire visual images of the viewing area that may then be processed to detect and/or identify viewer(s) present in the viewing area. In another example, I/O 118 may include one or more microphones configured to detect sound(s) that may be produced by viewer(s) present in the viewing area. The detected sound(s) may then be processed to detect and/or identify viewers present in the viewing area. In another example, I/O 118 may include a receiver configured to receive radio frequency signals corresponding to frequencies used by cellular telephones and/or wireless internet devices (e.g., ultra high frequency (UHF) signal(s)) present in the viewing area. In another example, I/O 118 may include one or more motion sensors configured to detect motion (e.g., of viewer(s) present) in the viewing area. One or more of the acquired visual images, detected sound(s), received UHF signals and/or motion data may then be processed by viewer presence detection module 106 to determine whether viewer(s) are present and/or to identify viewer(s) who are present.

A viewer who has agreed to participate in an incentive program, consistent with the present disclosure, may provide identification information (e.g., cellular telephone number, a device's Bluetooth MAC address, RFID tag identifier) and/or may participate in an identification information setup sequence (e.g., a learning sequence for the image and/or audio processing of the viewer presence detection module 106).

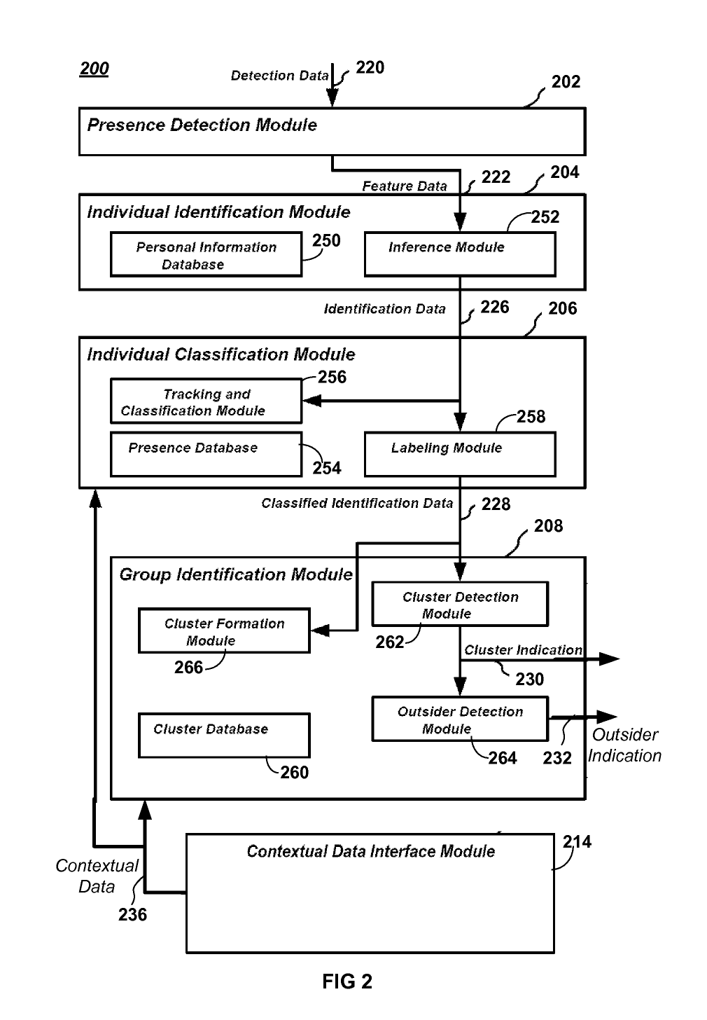

An example of viewer presence detection is given in U.S. patent application Ser. No. 12/821,376, filed on Jun. 23, 2010, and assigned to the same assignee as the present application. FIG. 2 is a diagram showing an exemplary implementation 200 of viewer presence detection module 106. As shown in FIG. 2, implementation 200 includes a presence detection module 202, an individual identification module 204, an individual classification module 206, a group identification module 208, and a contextual data interface module 214. These elements may be implemented in any combination of hardware and/or software. Moreover, implementation 200 includes elements (e.g., database modules) that may store information. Thus, implementation 200 may include storage media (e.g., memory) to provide such storage features. Examples of storage media are provided below.

As shown in FIG. 2, implementation 200 receives detection data 220 regarding a detection space (e.g., the viewing area). This data may be received directly from one or more devices (e.g., I/O 118). Alternatively or additionally, this data may be received from a storage medium. Accordingly, detection data 220 may include information, such as camera images, audio signals, accelerometer measurements, and so forth. Also, detection data 220 may include identifiers that indicate particular individuals. Such identifiers may be in the form of wireless communications addresses (e.g., MAC addresses), RFID tag identifier(s) (e.g., worn by viewer(s)), and so forth.

From detection data 220, presence detection module 202 determines the presence of one or more individuals (if any) within the detection space. This may involve various signal/image processing and/or pattern recognition operations. In turn, presence detection module 202 generates feature data 222 for each detected individual. In embodiments, feature data 222 may convey one or more features (e.g., facial features, height, size, voice parameters, etc.) extracted through image/signal processing techniques. Additionally or alternatively, feature data 222 may include identifiers (e.g., communications device addresses, RFID tag identifiers, etc.) Embodiments are not limited to these examples.

Individual identification module 204 identifies such detected persons. This identification is based at least on feature data 222. In embodiments, this identification may involve matching features of detected persons with known features of individuals. Such known features may be stored within a personal information database 250. FIG. 2 shows that individual identification module 204 may include an inference module 252. Inference module 252 includes control logic that makes statistical inferences (conclusions) based at least on feature data 222. Also, these inferences may be based on information stored in personal information database 250. These inferences result in the generation of identification data 226, which is sent to individual classification module 206. Identification data 226 includes one or more indicators, each indicating a person currently identified in the detection space.

Individual classification module 206 manages classifications of individuals identified by individual identification module 204. This may involve assigning new classifications, as well as updating existing classifications, for identified individuals. As shown in FIG. 2, individual classification module 206 includes a presence database 254, a tracking and classification module 256, and a labeling module 258.

Presence database 254 maintains classification information for multiple individuals. More particularly, for each of the individuals, presence database 254 stores corresponding classification metadata. This metadata indicates an individual's classification. As described above, exemplary classifications include child, adult, female, and male. Further examples are provided in the following table.

| Classification | Description |
|---|---|
| Family | Someone who is present often, |
| | and both day and night |
| Visiting family member | Someone who is not part of the |
| | regular family, but is living in |
| | the household for extended |
| | period of time. |
| Friend | Someone who is present |
| | frequently, but not every day, |
| | and usually not late at night. |
| Visitor | Someone who is present less |
| | often. |
| Stranger | Someone never seen before or |
| | seen extremely rarely. |

Also, presence database 254 maintains historical data regarding each of the individuals. For example, presence database 254 stores each identification of a particular individual. This may involve storing contextual information. Exemplary contextual information includes (but is not limited to) time of identification, other individuals identified with the particular individual, corresponding content viewing and selection(s) of the particular individual, and so forth. In embodiments, various contextual information may be received from contextual data interface module 214 as contextual data 236.

Tracking and classification module 256 assigns and updates classifications of individuals. FIG. 2 shows that tracking and classification module 256 receives identification data 226. As described above, identification data 226 indicates each person currently identified in the detection space. For each of these identifiers, tracking and classification module provides an update to presence database 254. This involves updating the historical data for the corresponding individual(s) in presence database 254.

Also, for each person indicated in identification data 226, tracking and classification module 256 performs classification operations to assign or update the person's classification. These classification operations involve determining a classification based on one or more factors. These factors may include (but are not limited to) any individuals currently identified with the person, current content selection(s), and historical data regarding the individual (e.g., data stored within presence database 254).

Further, the classification may be determined based on a consultation with a user via a user interface (e.g. through I/O 118). For example, a user may be queried to classify an identified person. Examples of such queries are provided below.

“I've seen Joe very often, is he a friend?”

“I've seen Joe lately, is he a friend?”

“Please indicate which category in which Joe should be classified: friend, family . . . none.”

Upon determining a classification for an individual, tracking and classification module 256 stores the classification (e.g., updates the classification) in presence database 254.

As shown in FIG. 2, identification data 226 is further forwarded to labeling module 258. For individual(s) indicated in identification data 226, labeling module 258 retrieves corresponding classification(s) from presence database 254. In turn, labeling module 258 includes the classification(s) in identification data. This produces classified identification data 228, which is sent to group identification module 208.

Group identification module 208 performs operations involving groupings of individuals (also referred to herein as clusters). As shown in FIG. 2, group identification module 208 includes a cluster database 260, a cluster detection module 262, an outsider detection module 264, and a cluster formation module 266.

Cluster database 260 stores sets or lists of individuals (clusters) that are often in the detection space together. Moreover, for each cluster, cluster database 260 may store corresponding contextual information. Examples of such contextual information are provided below.

Cluster detection module 262 determines whether a cluster (e.g., as defined by cluster database 260) is currently present in the detection space. FIG. 2 shows that cluster detection module 262 receives classified identification data 228. Based on this data, cluster detection module 262 determines whether any clusters (or cluster variants) are present. This determination may involve accessing cluster database 260 and comparing the individuals in data 228 with the clusters stored therein. From this, cluster detection module 262 may indicate a detected cluster in a cluster indication 230.

Outsider detection module 264 determines whether non-cluster members are present in combination with a cluster. More particularly, outsider detection module 263 may determine whether data 228 indicates people outside of a cluster that is identified in cluster indication 230. If so, the outsider detection module 264 identifies such person(s) in an outsider indication 232.

Cluster formation module 266 may identify the appearance (and frequency of appearance) of potentially new clusters. Also, cluster formation module 266 may modify existing clusters. This may be based on classified identification data 228, cluster indication 230, and/or outsider indication 232.

Cluster formation module 266 may form new clusters upon noticing the occurrence of individuals in groups. For instance, cluster formation module 208 may form a new cluster when such a grouping of individuals indicated by data 228 (that doesn't result in a cluster identification by cluster detection module 262) occurs at a particular frequency or regularity. When forming a new cluster, cluster formation module 208 may direct cluster database 260 to store a corresponding cluster definition.

Modifying an existing cluster involves changing the individuals associated with the cluster. Cluster formation module 208 may update a cluster when a variation in a cluster (e.g., the existence additional and/or omitted individuals) occurs at a particular frequency or regularity. When cluster formation module 266 identifies the occurrence of such conditions, it may modify a corresponding cluster definition in cluster database 260 or create a new cluster definition in cluster database 260.

Cluster operations (e.g., the identification of clusters, the formation of new clusters, and/or the modification of existing clusters) may be further based on contextual information. Such contextual information may pertain to events that coincide (or are proximate in time) with such operations.

Examples of contextual information include (but are not limited to) the day and time, personal calendar appointments (e.g., a birthday party), global calendar appointments (e.g., a holiday), and a TV schedule. Further, contextual information may include content selections associated with the group. For example, if five males get together on Friday evenings and view a football game, this group may be identified as a “football buddies” cluster associated with football or sporting events.

As shown in FIG. 2, group identification module 208 may receive such contextual information from contextual data interface module 214 (as contextual data 236). Contextual data 236 may indicate associated events, such as current day and time, calendar events, and so forth. Embodiments, however, are not limited to these examples.

Thus, the identification of clusters, as well as the identification of cluster variants (e.g., subsets/supersets/combinations of clusters and their variants) may be aided by contextual information. Moreover, clusters may be advantageously formed more quickly, with greater confidence, and be given a semantic meaning.

In some embodiments, identification of clusters and/or indication of outsiders may be used to select advertisement(s) for display. For example, if the cluster “football buddies” is identified, then sports oriented advertising may be displayed. Embodiments, however, are not limited to these examples.

Turning again to FIG. 1, in some embodiments, STB 110 may be configured to monitor signal(s) generated by a remote control associated with the STB 110 and/or the television 140. Signal(s) may be generated in response to selection(s) (e.g., key press(es)) on the remote control by, e.g., a viewer. For example, the STB 110 may be configured to monitor for changing channels and/or muting a selected channel. In this manner, viewer presence and/or viewer attention to displayed advertisement(s) may be further ascertained.

If a detected viewer has been previously identified, e.g., has a Viewer ID in the database, this previously assigned Viewer ID may be used (i.e., a new Viewer ID may not be assigned). If a new viewer (e.g., does not correspond to a previously identified viewer) is detected, a Viewer ID may be assigned and associated viewer identification information may be stored in storage 114. In some embodiments, viewer presence may be detected but the viewer(s) present may not be identified. In these embodiments, a default viewer ID, associated with a household may be used. The Viewer ID for each identified and present viewer may then be associated with Ad ID(s) for viewed advertisement(s), in, e.g., storage 114. The Ad ID(s) and associated Viewer IDs may be provided to the Reward Server 120 (by, e.g., the STB 110), in real time, i.e., upon viewing of the advertisement(s).

The Reward Server 120 may include a reward manager 124. The Reward Server 120 and the reward manager 124 may be configured to provide a reward to one or more of the viewer(s) that viewed the advertisement(s). For example, Reward Server 120 and reward manager 124 may be configured to select and/or determine the reward to be provided to each identified viewer determined to be present during display of the associated advertisement. In another example, Reward Server 120 and reward manager 124 may be configured to select and/or determine the reward to be provided to known household members when viewers are detected but not identified during display of an advertisement. In this example, the default Viewer ID, corresponding to the household, may be provided to the Reward Server 120.

The Reward Server 120 may be accessed by an advertiser 160 and/or may be configured to notify the advertiser 160 that advertisement(s) have been viewed. For example, the Reward Server 120 may be configured to provide information to the advertiser 160 that may include Ad ID(s) of advertisement(s) watched, information associated with the advertisement(s), e.g., time of day displayed, number of viewer(s) determined to be present during display of the advertisement(s), and/or Viewer ID(s) of the viewer(s) determined to be present. The Reward Server 120 may be configured to notify the advertiser 160, in “real time” that an advertisement has been viewed (i.e., within minutes of determining that the advertisement has been viewed).

Each reward may include an associated unique identifier (Reward ID), configured to allow redemption of the reward to be tracked. The Reward ID may be associated with the viewed advertisement, e.g., may be associated with the Ad ID of the viewed advertisement. The reward ID may also be associated with the specific viewer to whom the reward has been provided.

Whether a reward is provided and information associated with each reward may depend on a reward policy set by an advertiser. The Reward Server 120 may include storage 122 configured to store information associated with the reward policy and/or information associated with each reward, e.g., Ad ID of the viewed advertisement associated with the Reward ID and/or Viewer ID of the viewer that was provided the associated reward. In some embodiments, the reward policy may be based, at least in part, on a past history associated with a specific viewer (and/or Viewer ID). Past history may include, but is not limited to, Ad IDs of viewed advertisements, reward(s) received, reward(s) redeemed, length of time between receipt of reward(s) and redemption of the reward(s), and/or whether the particular viewer shared the reward(s) and with whom.

Information associated with each reward may include, but is not limited to, Reward ID, type of reward (e.g., coupon), amount of reward, time limit for redeeming reward, and/or whether the reward may be shared. For example, if the reward is a coupon, information associated with each coupon may include, but is not limited to, a unique coupon identifier (Coupon ID), a percent off a price of the advertised product and/or service, an expiration date of coupon, whether a coupon may be shared, a number of times a coupon may be utilized, a number of product(s) that may be purchased with the coupon, whether a number of product(s) may be purchased for a price of a lesser number of product(s) (e.g., buy one get one free, buy two and get a third at half price). For example, each viewer may be provided a coupon, including a unique coupon identifier (Coupon ID), toward a purchase of the advertised product and/or service. Advantageously, when the coupon is redeemed, the Coupon ID may be used to associate the purchase with the viewer and/or viewed advertisement(s), providing confirmation that the viewed advertisement(s) resulted in a sale.

Each reward may be provided from the Reward Server 120 to one or more viewer device(s) 150. As used herein, the term “viewer device” is intended to include any device that is capable of accessing a network, e.g., a telephone network and/or the Internet, wired and/or wirelessly. For example, a viewer device may be a cellular telephone. In another example, a viewer device may be a personal computer, e.g., a laptop computer. In yet another example, a viewer device may be a “mobile internet device” generally configured for wireless internet access in order to provide entertainment, information and/or location-based services for a user. Mobile internet devices may include, but are not limited to, “smart phones” configured to provide wireless telephony and/or wireless internet access, “ultra mobile PCs”, “Netbooks”, tablet computers and/or “notebook computers”.

In some embodiments, each reward may be provided from the Reward Server 120 to the viewer device(s) 150 via the STB 110. In other embodiments, each reward may be provided to the viewer device(s) 150 without going through the STB 110. In some embodiments, each reward may be provided to the Television 140 through the STB 110. In some embodiments, reward(s) may be sent by postal mail. If the reward is sent electronically, the reward may be provided to the viewer device(s) in real time, i.e., within a relatively short time (e.g., minutes) of the advertisement(s) being viewed. For example, each reward and Reward ID may be transmitted to an associated viewer device using a cellular telephone network. In another example, each reward and Reward ID may be transmitted to an associated viewer device using a computer network, e.g., the internet. In yet another example, the reward may be transmitted to the STB for forwarding to the associated viewer device. Other methods may be used as will be understood by those skilled in the art.

A viewer 170 may share a reward with one or more friend(s) and/or associate(s) 175. The Reward ID may be associated with the viewed advertisement and the identified viewer present during display of the advertisement. When the reward is redeemed by a friend and/or associate, information about the friend and/or associate may also be acquired. Although the friend(s) and/or associate(s) 175 may not have viewed the associated advertisement, sharing reward(s) in this manner may result in increased sales of the advertised product(s) and/or service(s). In other words, reward-sharing may provide additional “word of mouth” advertising and inherent endorsement of the advertised product(s) and/or service(s) by the viewer to the viewer's friend(s) and/or associate(s). Reward-sharing may increase a number of viewers who participate in incentivized advertisement watching and associated purchase-tracking, as described herein. A viewer who has shared a reward may be provided with additional bonus reward for recommending the advertised product and/or service to friend(s) and/or associate(s), as described herein.

The Reward Server 120 and reward manager 124 may be configured to provide an associated Ad ID, associated Viewer ID and associated Reward ID for each reward and/or viewer to the Loyalty Program Server 130. The Loyalty Program Server 130 may include a customer loyalty program manager 134 and storage 132 configured to store information associated with an advertiser's customer loyalty program. A viewer may choose to participate in the advertiser's customer loyalty program. Participating viewers may then receive additional rewards based on, e.g., advertisement viewership, purchase history, and/or reward-sharing.

For example, storage 132 may include a database (i.e., list) of Viewer IDs and associated information for viewers who have chosen to participate in the customer loyalty program. The database may include, for each Viewer ID, Ad IDs for viewed advertisement(s), Reward ID(s), and/or other information associated with the advertiser's customer loyalty program. Information associated with an advertiser's customer loyalty program may include, but is not limited to, Viewer ID, purchase history, history of viewed advertisements, viewer-specific information, reward(s) received, reward(s) redeemed, bonus reward(s) accrued, bonus reward(s) redeemed and/or friend(s) and/or associate(s) with whom rewards have been shared.

The Loyalty Program Server 130 and customer loyalty program manager 134 may be configured to provide a bonus reward (Bonus) to a viewer based, at least in part, on advertisement(s) viewed. For example, a viewer may earn a bonus reward for viewing a predetermined number of displayed advertisements. Such bonus rewards may provide a further incentive to each viewer to view displayed advertisement(s). Whether a bonus reward is provided may depend on a bonus policy set by an advertiser. Bonus rewards may include, but are not limited to, points that may be accrued toward obtaining additional product(s) and/or service(s), additional coupon(s), and/or other rewards known to those skilled in the art.

The Loyalty Program Server 130 and customer loyalty program manager 134 may be configured to receive redeemed reward information, as described herein. The Loyalty Program Server 130 may then update loyalty information for one or more viewer(s) based, at least in part, on the redeemed reward. The Loyalty Program Server 130 may be configured to provide a bonus reward based, at least in part, on redeemed reward(s), further incentivizing viewing advertisements and purchasing advertised product(s) and/or service(s). Whether the bonus reward is provided may depend on a bonus policy set by an advertiser. Accordingly, bonus reward(s) may be provided to viewer(s) based, at least in part, on, e.g., advertisement viewership, purchase history and/or reward-sharing. A viewer may then be incentivized to view advertisements, make associated purchases and “advertise” to friend(s) and/or associate(s).

For example, after advertisement(s) have been viewed and a reward (including a unique Reward ID) has been provided to viewer device(s) 150, a Viewer 170 may retrieve the reward and/or Reward ID from the viewer device(s) 150. For example, a viewer 170 may retrieve coupon(s) including Coupon ID(s) from viewer device(s) 150. The Viewer 170 may then use the coupon(s) and/or Coupon ID(s) to purchase the advertised product(s) and/or service(s), i.e., may redeem the coupon(s). The Viewer 170 may share the coupon(s) and/or Coupon ID(s) with other(s) (e.g., friend(s) and/or associate(s) 175) who may then use the coupon(s) and/or Coupon ID(s). Sharing reward(s) may be a form of “free” advertising for a product and/or service, that may result in additional sales of the product and/or service associated with a viewed advertisement.

The coupon(s) and/or Coupon ID(s) may be used to purchase the product(s) and/or service(s) from a retailer 180 online and/or in a retail store, as will be understood by those skilled in the art. When each reward (coupon) is redeemed, the reward ID (coupon ID) may be forwarded to the advertiser 160 by, e.g., retailer 180, providing direct confirmation to the advertiser 160 that a displayed advertisement was viewed and at least one sale resulted. If a reward having an associated Reward ID is redeemed a number of times (e.g., because a viewer has shared the reward) the advertiser may then receive direct confirmation that, not only was the advertisement viewed, but also, that the advertisement resulted in the number of sales of the advertised product and/or service.

The reward ID of each redeemed reward may be provided to the Loyalty Program Server 130 by, e.g., advertiser 160. Information associated with the Viewer ID associated with the redeemed reward ID(s) may then be updated and a bonus reward may be provided to the viewer 170, as described herein. Use of a shared reward may be credited to the viewer to whom the reward was delivered and/or to the person that redeemed the reward.

Accordingly, system 100 may be used to provide an incentive to a viewer 170 to watch a television advertisement by providing a reward (e.g., coupon) in response to a viewer watching the television advertisement. System 100 is configured to verify that the viewer 170 watched the advertisement and to notify the advertiser 160 and/or provide the reward upon verification. Use of the reward to make a purchase associated with the viewed advertisement may then be tracked and may then provide direct confirmation to the advertiser 160 that an advertisement was watched and a sale resulted. Additional information may also be collected and analyzed that may facilitate scheduling advertisements and targeting viewers. For example, date/time that the advertisement was displayed, whether a reward was shared, and/or other information as described herein, may be collected and analyzed.

### Exemplary Methodology

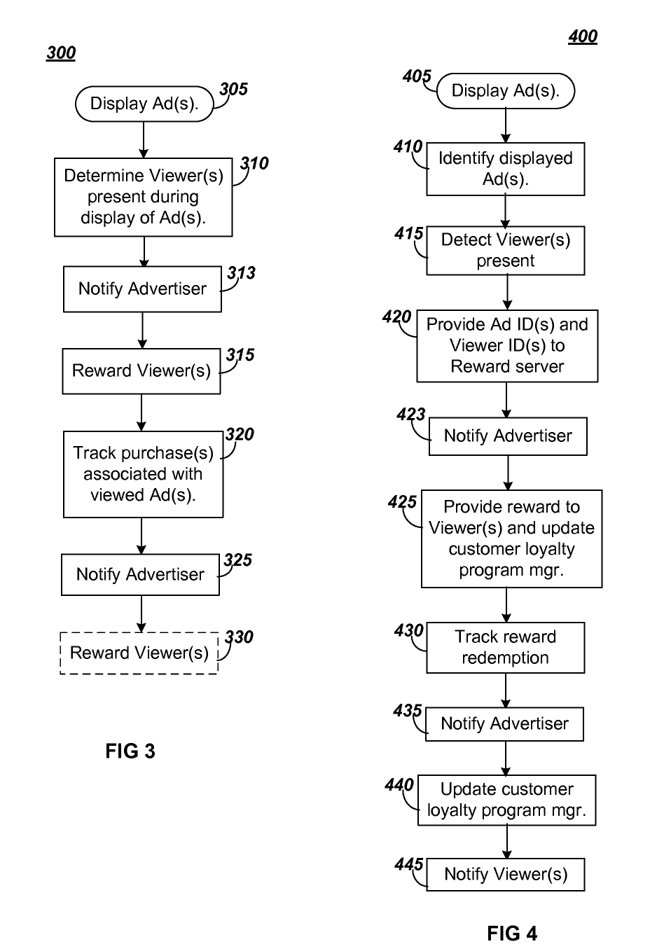

FIG. 3 illustrates a flowchart 300 of example operations consistent with the present disclosure. The operations illustrated in this embodiment may be performed by circuitry and/or software modules associated with a set-top box (e.g., STB 110), Reward Server 120 and/or Loyalty Program Server 130. Operations of this embodiment include displaying advertisement(s) 305. The advertisement(s) may be displayed during a break (“commercial break”) in a display of broadcast, broadband and/or stored content, and/or the advertisement may displayed as an overlay during display of the broadcast, broadband and/or stored content.

Whether one or more viewer(s) are present during display of the advertisement(s) may be determined at operation 310. Operation 310 may include identifying the viewer(s) present. An advertiser may be notified of advertisement(s) viewed and/or viewer(s) present at operation 313. Viewer(s) determined to be present during the advertisement may be rewarded at operation 315. For example, one or more of the viewer(s) determined to be present and/or identified may be provided a reward (e.g., a coupon). The reward may be provided to an associated viewer device for retrieval by an associated viewer. Operation 320 may include tracking purchase(s) associated with the viewed advertisement(s). For example, the reward ID for each reward may be used to track purchases associated with viewed advertisement(s). At operation 325, an advertiser may be notified that an advertised product and/or service was purchased using the reward with its associated reward ID. Operation 330 may include further rewarding viewer(s). For example, viewer(s) who make a predetermined number of tracked purchases may receive bonus reward(s). In another example, viewer(s) who participate in an advertiser's customer loyalty program may receive bonus reward(s), based at least in part, on their associated purchases.

The operations described herein are configured to provide an incentive to a viewer to view advertisement(s) displayed during breaks in, and/or during display of, broadcast, broadband and/or stored content. Advertiser(s) may be notified of advertisement(s) viewed. Viewer(s) determined to be present may be incentivized by being rewarded for viewing advertisement(s). Each reward may include a unique identifier (Reward ID) configured to allow tracking a purchase associated with the viewed advertisement. In this manner, a viewer is provided an incentive to view displayed advertisement(s), advertiser(s) may be provided confirmation that advertisement(s) were viewed and advertiser(s) may be provided confirmation that a viewed advertisement resulted in a sale of product(s) and/or service(s).

FIG. 4 illustrates another flowchart 400 of example operations consistent with the present disclosure. The operations illustrated in this embodiment may be performed by circuitry and/or software modules associated with a set-top box (e.g., STB 110), Reward Server 120 and/or Loyalty Program Server 130. Advertisement(s) for product(s) and/or service(s) may be displayed, e.g., on television 140, at operation 405. Each advertisement displayed may be identified at operation 410. Operation 415 may include detecting whether any viewer(s) are present during display of the advertisement(s). Operation 415 may further include identifying viewers who are present. Each viewer who is identified may be associated with a unique Viewer ID. If a detected viewer has been previously identified, the associated viewer ID may be retrieved at operation 415. If a detected viewer does not correspond to any identified viewer in the database, a new viewer ID may be assigned and viewer identification information may be stored, associated with the new viewer ID. If a viewer is present but not identified, a default Viewer ID, corresponding to the household, may be used. Operation 420 may include providing Ad IDs and Viewer IDs to a Reward Server for each viewer and viewed advertisement. The Ad IDs and Viewer IDs are configured to allow correlation of viewer(s) with viewed advertisement(s). For example, for each viewed advertisement, its associated Ad ID and Viewer ID(s) of viewer(s) that viewed the advertisement may be provided to a reward server, e.g., Reward Server 120. Operation 423 may include notifying advertiser(s) that advertisement(s) were viewed.

Viewer(s) that viewed advertisement(s) may be rewarded at operation 425. Reward(s) including Reward IDs may be provided to the viewer(s) via, e.g., viewer device(s) 150. Operation 425 may include updating a customer loyalty program manager with a Viewer ID, Ad ID(s) for each advertisement viewed, and a Reward ID for each reward provided to the viewer(s).

Whether a reward is redeemed may be tracked at operation 430. For example, the reward may be a coupon configured to allow a product and/or service to be purchased at a reduced price. The reward may be tracked using its associated Reward ID. At operation 435 an advertiser may be notified that a reward has been redeemed. For example, the advertiser may be provided the Reward ID associated with the redeemed reward. Redemption of the reward with Reward ID is configured to provide confirmation to the advertiser that the viewed advertisement associated with that Reward ID resulted in at least one sale of product and/or service.

A customer loyalty program manager may be updated at operation 440. For example, a viewer customer loyalty account for the Viewer ID associated with the redeemed Reward ID may be updated to reflect that a reward was redeemed. Operation 440 may include applying a bonus reward to a customer loyalty account associated with a viewer, e.g., in response to redeeming a reward. At operation 445 a viewer may be notified that the viewer's customer loyalty account has been updated to include a bonus reward. In this manner, a viewer may be rewarded for making a purchase and redeeming a reward. If the reward is redeemed by an associate and/or friend of the viewer, the viewer's customer loyalty account may also be updated. In this manner, the viewer may be additionally rewarded for sharing the reward and providing an informal endorsement of the advertised product and/or service associated with the viewed advertisement.

The operations described herein are configured to provide an incentive to (i.e., incentivize) viewer(s) for watching advertisement(s). Whether a viewer is present during display of advertisement(s) may be determined without action by the viewer. Viewer(s) determined to be present may be provided reward(s), in real time. The reward(s) are configured to allow tracking to provide advertisers with direct confirmation that a viewed advertisement resulted in a sale of product. Viewer(s) may be further rewarded based, at least in part, on advertisement(s) viewed, reward(s) received, reward(s) shared, product(s) and/or service(s) purchased and/or reward(s) redeemed.

An exemplary system is described herein. Modifications are possible. For example, memory 116 may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively, memory 116 may comprise other and/or later-developed types of computer-readable memory.

Embodiments of the methods described herein may be implemented in a system that includes one or more storage mediums having stored thereon, individually or in combination, instructions that when executed by one or more processors perform the methods. Here, the processor may include, for example, a system CPU (e.g., CPU 112 of FIG. 1) and/or programmable circuitry. The processor may include a CPU and/or programmable circuitry (not shown) included in the Reward Server 120 and/or the Loyalty Program Server 130. Thus, it is intended that operations according to the methods described herein may be distributed across a plurality of physical devices, such as processing structures at several different physical locations. Of course, the operations described herein as attributable to the STB, Reward Server and/or Loyalty Program Server could be performed by a storage medium, on one or another, having instructions that when executed by one or more processors perform the methods. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage media 114, 122, 132 may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry.

According to one aspect there is disclosed an apparatus configured to provide an incentive to a viewer to view a displayed advertisement. The apparatus may include a set-top box configured to: provide an advertisement to at least one of a television and a display device for display, identify the displayed advertisement, determine whether the viewer is present during display of the advertisement, and notify a reward server that the viewer was present during the displayed advertisement.

According to another aspect there is disclosed a system, including one or more storage mediums having stored thereon, individually or in combination, instructions that when executed by one or more processors may result in the following operations:

determining whether a viewer is present during display of an advertisement; and providing a first reward to the viewer present during display of the advertisement, wherein the first reward is configured to provide an incentive to the viewer to view the displayed advertisement and to provide incentive to purchase at least one of a product and a service associated with the displayed advertisement.

In yet another aspect there is disclosed a system configured to provide an incentive to a viewer to view a displayed advertisement. The system may include a set top box configured to determine whether the viewer is present during display of the advertisement; and a reward server configured to provide a first reward to the viewer present during display of the advertisement, wherein the first reward is configured to provide an incentive to the viewer to view the displayed advertisement and to provide an incentive to purchase at least one of a product and a service associated with the displayed advertisement.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. An apparatus configured to provide an incentive to a viewer to view a displayed advertisement, the apparatus comprising:
a set-top box configured to:
provide an advertisement to at least one of a television and a display device for display,
identify the displayed advertisement,
determine whether the viewer is present during display of the advertisement, and
notify a reward server that the viewer was present during the displayed advertisement.

2. The apparatus of claim 1, further configured to receive a reward from the reward server, wherein the reward is designed to provide an incentive to the viewer to view another displayed advertisement and to purchase at least one of a product and a service associated with the displayed advertisement and wherein the reward includes an identifier configured to allow tracking of a purchase associated with the displayed advertisement.

3. The apparatus of claim 1, wherein the set-top box is configured to identify the viewer present during display of the advertisement.

4. The apparatus of claim 1, wherein the set-top box is configured to determine whether a viewer is present during display of the advertisement by acquiring at least one of an image from a viewing area, a sound signal from the viewing area, and a signal from a viewer device present in the viewing area, wherein the viewing area is a physical region from which the displayed advertisement is viewable.

5. The apparatus of claim 3, wherein the set-top box is configured to identify the viewer present during display of the advertisement by processing at least one of an image acquired from a viewing area, a sound signal acquired from the viewing area, and a signal acquired from a viewer device present in the viewing area, wherein the viewing area is a physical region from which the displayed advertisement is viewable.

6. The apparatus of claim 1, wherein the set-top box is configured to provide the reward server a unique advertisement identifier for each displayed advertisement where at least one viewer was present and a viewer identifier corresponding to the viewer present during the displayed advertisement wherein the unique advertisement identifier and the viewer identifier are configured to provide confirmation to an advertiser that the displayed advertisement was viewed.

7. The apparatus of claim 1, wherein the set-top box is configured to provide a reward to at least one of the television and a viewer device wherein the reward is configured to provide an incentive to the viewer to view another displayed advertisement and to purchase at least one of a product and a service associated with the displayed advertisement and wherein the reward includes an identifier configured to allow tracking of a purchase associated with the displayed advertisement.

8. A system comprising, one or more storage mediums having stored thereon, individually or in combination, instructions that when executed by one or more processors result in the following operations comprising:
determining whether a viewer is present during display of an advertisement; and
providing a first reward to the viewer present during display of the advertisement,
wherein the first reward is designed to provide an incentive the viewer to view the displayed advertisement and to provide incentive to purchase at least one of a product and a service associated with the displayed advertisement.

9. The system of claim 8, wherein the first reward includes an identifier configured to allow tracking of a purchase associated with the displayed advertisement.

10. The system of claim 8, wherein the instructions that when executed by one or more of the processors result in the following additional operations comprising:
identifying the viewer present during display of the advertisement.

11. The system of claim 8, wherein the instructions that when executed by one or more of the processors result in the following additional operations comprising:
providing the viewer present during display of the advertisement a bonus reward in response to a purchase associated with the displayed advertisement.

12. The system of claim 8, wherein the instructions that when executed by one or more of the processors result in the following additional operations comprising:
notifying an advertiser in response to a purchase associated with the displayed advertisement.

13. The system of claim 8, wherein the instructions that when executed by one or more of the processors result in the following additional operations comprising:
providing an additional reward to the viewer in response to the viewer sharing the first reward with at least one of a friend or associate.

14. A system configured to provide an incentive to a viewer to view a displayed advertisement, the system comprising:
a set top box configured to determine whether the viewer is present during display of the advertisement; and
a reward server configured to provide a first reward to the viewer present during display of the advertisement, wherein the first reward is designed to provide an incentive to the viewer to view the displayed advertisement and to provide an incentive to purchase at least one of a product and a service associated with the displayed advertisement.

15. The system of claim 14, wherein the first reward includes an identifier configured to allow tracking of a purchase associated with the displayed advertisement.

16. The system of claim 14, wherein the set top box is further configured to identify the viewer present during display of the advertisement.

17. The system of claim 14, further comprising a loyalty program server configured to provide the viewer a bonus reward in response to a purchase associated with the displayed advertisement.

18. The system of claim 14, wherein the first reward is configured to provide notification to an advertiser in response to a purchase associated with the displayed advertisement.

19. The system of claim 14, further comprising notifying an advertiser in response to a viewer being present during display of the advertisement.

20. The system of claim 14, further comprising a loyalty program server configured to provide the viewer an additional reward in response to the viewer sharing the first reward with at least one of a friend or associate.
